(19) United States
(12) Patent Application Publication
(10) Pub. No.: US 2011/0078176 A1
(43) Pub. Date: Mar. 31, 2011

(54) IMAGE SEARCH APPARATUS AND METHOD

(75) Inventor: Ikuo Hayaishi, Dun Laoghaire (IE)

(73) Assignee: SEIKO EPSON CORPORATION, Shinjuku-ku (JP)

(21) Appl. No.: 12/889,325

(22) Filed: Sep. 23, 2010

(30) Foreign Application Priority Data
Sep. 25, 2009 (JP) 2009-221095

(51) Int. Cl. G06F 17/30

(52) U.S. Cl. 707/769; 707/E17.039

(57) ABSTRACT

An apparatus includes a string-accepting section that accepts a string; a first retrieval section that retrieves a first characteristic to be used for image search from a database storing sensitivity words and nouns in association with characteristics using a combination of a sensitivity word and a noun extracted from the string; and a search section that searches for an image using the first characteristic.

Priority is claimed under 35 U.S.C. §119 to Japanese Application No. 2009-221095 filed on Sep. 25, 2009, which is hereby incorporated by reference in its entirety.

### BACKGROUND

1. Technical Field

The present invention relates to image search technology using image databases.

2. Related Art

Various techniques for searching for desired information via a network have been practically used. As information search using keywords (strings), for example, search for images associated with additional information (string information), such as captions and annotations, has been practically used. As information search using keywords, for example, JP-A-2004-86307 proposes information search using natural text containing a plurality of words.

However, image search using a string or natural text containing a plurality of words leaves room for improvement in search accuracy and speed.

This problem applies not only to image search, but also to search for other types of content, including video, music, games, and electronic books.

### SUMMARY

An advantage of some aspects of the invention is that it improves search accuracy and speed in search using a string or natural text containing a plurality of words.

According to a first aspect of the invention, an image search apparatus is provided. The image search apparatus according to the first aspect includes a string-accepting section that accepts a search string containing a plurality of words, a characteristic-retrieving section that retrieves image characteristics using the accepted string, and an image search section that searches an image database storing a plurality of images in association with characteristics for an image corresponding to the string using the retrieved characteristics.

The image search apparatus according to the first aspect retrieves image characteristics using an accepted string and searches the image database storing a plurality of images in association with characteristics for an image corresponding to the string using the retrieved characteristics. This improves search accuracy and speed in search using a string containing a plurality of words.

In the image search apparatus according to the first aspect, the string may be natural text, the image search apparatus may further include a word-segmenting section that segments the accepted string into words serving as keywords and a word-characteristic database storing words serving as keywords in association with image characteristics, and the characteristic-retrieving section may retrieve the characteristics to be used for search from the word-characteristic database using the words obtained by the segmentation. In this case, the characteristics to be used for search are retrieved from the word-characteristic database on the basis of words segmented from natural text. This improves search accuracy and speed in search using natural text.

In the image search apparatus according to the first aspect, the words serving as keywords may be a sensitivity word and a noun, the word-characteristic database may store combinations of a sensitivity word and a noun in association with characteristics, and the characteristic-retrieving section may retrieve the characteristics to be used for search from the word-characteristic database using the combination of a sensitivity word and a noun obtained by the segmentation. In this case, the characteristics to be used for image search can be retrieved on the basis of a combination of a sensitivity word and a noun. This allows systematic search, thus improving the search accuracy.

In the image search apparatus according to the first aspect, the word-characteristic database may store words in association with types and values of characteristics, and the characteristic-retrieving section may retrieve types and values of characteristics to be used for search on the basis of the words. In this case, the characteristics corresponding to the individual words can be appropriately specified, thus improving the search accuracy.

The image search apparatus according to the first aspect may be connected to a keyword-identifier database storing keywords in association with identifiers, the image database may store images in association with identifiers and image characteristics, and the image search section may retrieve corresponding identifiers from the keyword-identifier database using the accepted words serving as keywords and retrieve an image from the image database using the retrieved identifiers instead of the image characteristics. In this case, image search can be executed using identifiers, thus improving the image search speed.

The image search apparatus according to the first aspect may be connected to an image database storing a plurality of images in association with characteristics, and the image search section may search for an image by calculating similarity between the retrieved characteristics and the characteristics stored in the image database. In this case, the image database can be searched for a corresponding image.

In the image search apparatus according to the first aspect, if the accepted string contains a plurality of words, the characteristic-retrieving section may retrieve characteristics associated with the individual words, and the image search section may search for an image on the basis of the retrieved characteristics. In this case, a larger number of characteristics can be used for image search, thus improving the search accuracy.

According to a second aspect of the invention, an image search method is provided. The image search method according to the second aspect includes accepting a search string containing a plurality of words, retrieving image characteristics using the accepted string, and searching an image database storing a plurality of images in association with characteristics for an image corresponding to the string using the retrieved characteristics.

The image search method according to the second aspect provides the same operation and advantages as the image search apparatus according to the first aspect and can be implemented in various manners as in the first aspect.

The image search method according to the second aspect can be implemented as an image search program or a computer-readable medium having an image search program recorded thereon.

### BRIEF DESCRIPTION OF THE DRAWINGS

The invention will be described with reference to the accompanying drawings, wherein like numbers reference like elements.

FIG. 1 is a diagram schematically showing the configuration of an image search system according to a first embodiment of the invention.

FIG. 2 is a function block diagram schematically showing the internal configuration of an image server according to the first embodiment.

FIG. 3 is a table showing an example of an image database according to the first embodiment.

FIG. 4 is a table showing an example of a word-characteristic database according to the first embodiment.

FIG. 5 is a diagram showing a program stored in a memory of the image server according to the first embodiment.

FIG. 6 is a function block diagram schematically showing the internal configuration of a printer according to the first embodiment.

FIG. 7 is a diagram showing a program stored in a memory of the printer according to the first embodiment.

FIG. 8 is a flowchart showing an image search process routine executed by the image server according to the first embodiment.

FIG. 9 is a table showing a first example of results of morphological analysis.

FIG. 10 is a table showing a second example of results of morphological analysis.

FIG. 11 is a flowchart showing an image search request process routine executed by the printer according to the first embodiment.

FIG. 12 is a diagram showing an example of an image search result screen displayed on the printer according to the first embodiment.

FIG. 13 is a function block diagram schematically showing the internal configuration of an image server according to a second embodiment of the invention.

FIG. 14 is a table showing an example of a sensitivity word and noun-image characteristic database according to the second embodiment.

FIG. 15 is a flowchart showing a first image search process routine executed by the image server according to the second embodiment.

FIG. 16 is a flowchart showing a second image search process routine executed by the image server according to the second embodiment.

FIG. 17 is a flowchart showing a third image search process routine executed by the image server according to the second embodiment.

FIG. 18 is a function block diagram schematically showing the internal configuration of an image server according to a third embodiment of the invention.

FIG. 19 is a table showing an example of an image database according to the third embodiment.

FIG. 20 is a table showing an example of a word-identifier database according to the third embodiment.

FIG. 21 is a flowchart showing a process routine executed for image search according to the third embodiment.

FIG. 22 is a table showing another example of the word-identifier database according to the third embodiment.

### DESCRIPTION OF EXEMPLARY EMBODIMENTS

Image search systems, image servers, image search methods, and printers and personal computers serving as image search terminals according to embodiments of the invention will now be described with reference to the drawings.

### First Embodiment

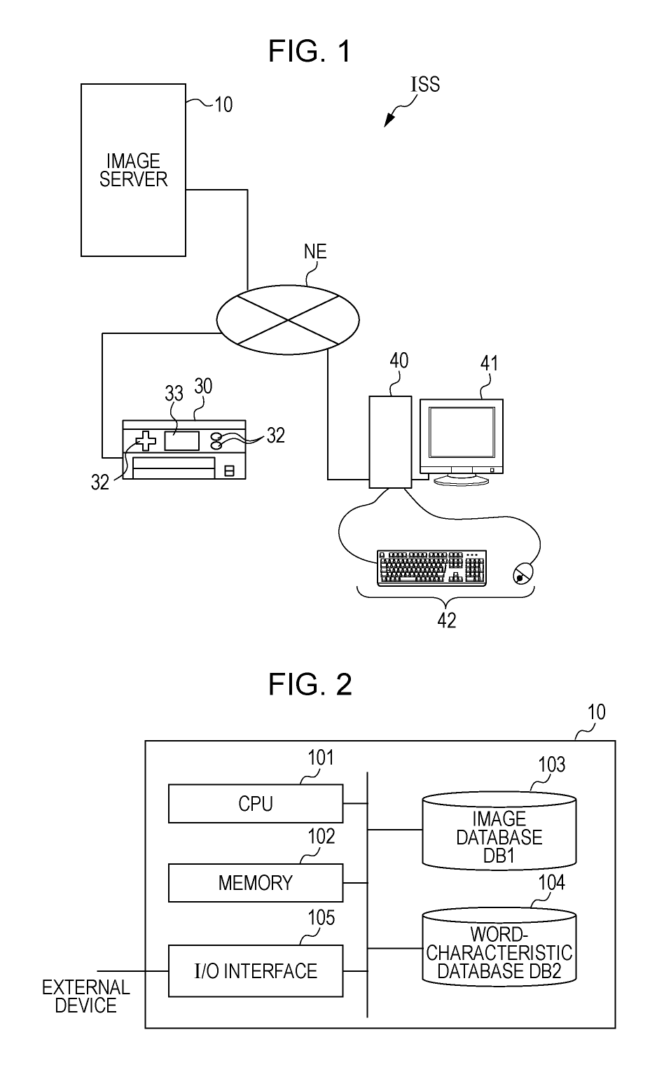

FIG. 1 is a diagram schematically showing the configuration of an image search system according to a first embodiment of the invention. An image search system ISS according to this embodiment includes a server computer 10 serving as an image server, a printer 30, and a personal computer 40. The server computer 10, the printer 30, and the personal computer 40 are connected so as to be capable of two-way communication via a network NE. The network NE may be the Internet or an intranet.

The server computer 10 stores a plurality of image data items to be searched for in association with one or more characteristics and searches for images in response to a search request from a client computer. Thus, the server computer 10 serves as an image server including an image database or an image search apparatus that searches for image data. The printer 30 and the personal computer 40 serve as a client computer or image search terminal that requests the image server 10 for image search. The personal computer 40 includes a display 41 and input devices 42 such as a keyboard and a mouse.

### Configuration of Image Server

FIG. 2 is a function block diagram schematically showing the internal configuration of the image server 10 according to this embodiment. The image server 10 includes a central processing unit (CPU) 101, a memory 102, a first storage device 103 having an image database DB1 created therein, a second storage device 104 having a word-characteristic database DB2 created therein, and an input/output (I/O) interface 105 that are connected so as to communicate each other. The CPU 101 executes various programs and modules stored in the memory 102. The memory 102 stores the programs and modules to be executed by the CPU 101 in a nonvolatile manner and has a volatile work space where the programs and modules are loaded when executed by the CPU 101. The memory 102 used may be, for example, a semiconductor storage device such as a read-only memory that stores programs and modules in a nonvolatile manner or a random access memory that provides a volatile work space upon execution of programs and modules, or may be a magnetic hard disk drive or high-capacity flash memory drive in which data can be recorded in a nonvolatile manner.

The first and second storage devices 103 and 104 are constituted by, for example, one or more high-capacity storage devices such as hard disk drives or flash memory drives. That is, the two storage devices 103 and 104 may be implemented either by logically dividing one high-capacity storage device into two storage devices or by providing two physically separate storage devices. The first storage device 103 has the image database DB1 created therein, which stores image data items in association with image characteristics. The second storage device 104 has the word-characteristic database DB2 created therein, which stores words (herein also referred to as “morphemes”) in association with image characteristics. An image is an image data item output (e.g., displayed or printed) by a device; it is obvious to those skilled in the art that an image to be processed means an image data item in the claims.

Although described as an example in this embodiment is the case where the database DB1 is created in the first storage device 103 simply by storing image data items in association with image characteristics and the database DB2 is created in the second storage device 104 simply by storing words in association with image characteristics, the two storage devices 103 and 104 may be configured as independent database systems (file servers) that include a control section having a search function and that output search results in response to a search request from the outside. In this case, image database systems are provided outside the image server 10, and search requests and results are communicated therebetween via the I/O interface 105. In addition, a program for requesting database search and receiving search results is stored in the memory 102 and is executed by the CPU 101. The association of image data items with image characteristics and the association of words with image characteristics are implemented using a table showing correspondences between image data items and image characteristics and a table showing correspondences between words and image characteristics. These tables may be provided in the two storage devices 103 and 104 or may be stored in the memory 102. In the former case, the two storage devices 103 and 104 identify image characteristics corresponding to the received words and retrieve image data items associated with image characteristics similar to those identified. In the latter case, the two storage devices 103 and 104 retrieve image characteristics or image data items according to logical addresses received from the CPU 101. In this case, a storage device having no database created therein can be searched for image data items.

The I/O interface 105 communicates search requests and results with an external device, for example, a client such as the printer 30 or the personal computer 40, according to a known communication protocol.

### Image Database

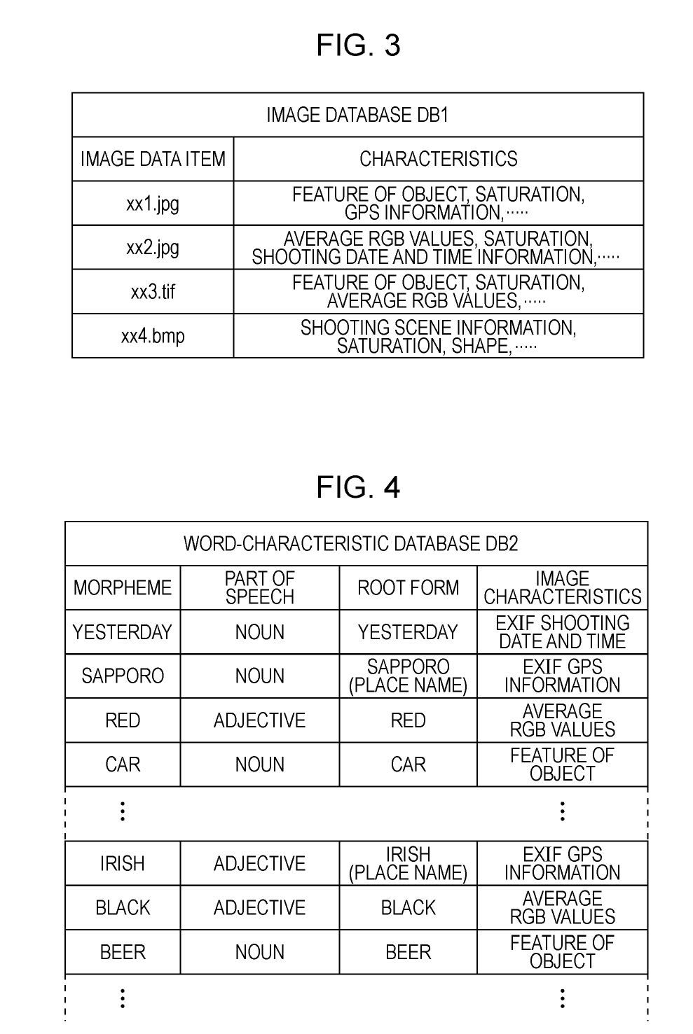

FIG. 3 is a table showing an example of an image database in this embodiment. In this embodiment, the image database DB1 is created in the storage device 103 by storing image data items in association with image characteristics. For example, as described above, the image database DB1 is implemented by a management table that associates image data items with image characteristics. The storage device 103 may also store image data items yet to be compiled into image database DB1.

Examples of types of image characteristics associated with image data items include features of objects, saturation, shape, and average RGB values, and examples of values of image characteristics include representative values, means, minima, maxima, and medians. Other forms of image characteristics include descriptive information, such as metadata, associated with image data items. These image characteristics are retrieved by, for example, sequentially retrieving image data items from the storage device 103 and analyzing the image data items by known methods to obtain values of image characteristics of the intended types, or by analyzing metadata associated with the image data items. Alternatively, the image characteristics are retrieved when the image data items to be stored in the storage device 103 are stored from an external storage device into the storage device 103. The image characteristics thus retrieved are stored in the storage device 103 in association with the image data items from which the image characteristics were retrieved to create the image database DB1 shown in FIG. 3. Preferably, the types of image characteristics associated with the image data items in the image database DB1 correspond to all types of image characteristics associated with words in the word-image characteristic database DB2.

The image characteristics retrieved from the image data items when creating the image database DB1 are obtained by statistically processing pixel data constituting the image data items. The technique for retrieving the image characteristics from the image data items needs no detailed description in this embodiment, which uses the image database DB1 already created; it will be discussed along with a third image search process of a second embodiment characterized by extraction of image characteristics.

### Word-Image Characteristic Database

FIG. 4 is a table showing an example of a word-image characteristic database in this embodiment. A word-image characteristic database DB2 shown in FIG. 4 is merely illustrative and may contain other words and image characteristics. In this embodiment, the word-image characteristic database DB2 is created in the storage device 104 by storing words in association with one or more image characteristics and values thereof. In the example in FIG. 4, the words (morphemes) used are “yesterday,” “Sapporo,” “red,” “car,” “Irish,” “black,” and “beer.”

Specifically, morphemes (words) are associated with part of speech, root form, and image characteristics. Shooting date and time and GPS information can be retrieved from Exif information (metadata carrying information such as shooting conditions) described in Exif tags of image files containing image data items. The types and addresses of information described in Exif tags are specified in advance so that desired information can be retrieved by pointing to the address corresponding to the desired information. Average RGB values and features of objects, as described above, are types and values obtained by statistically processing pixel data constituting image data items. The time-related word “yesterday” is associated with shooting date and time in Exif data as an image characteristic, whereas the place names “Sapporo” and “Irish” are associated with GPS information in Exif data. The shooting date and time associated with “yesterday” is not a parameter directly indicating “yesterday”; rather, it is determined by computing whether or not the shooting date and time is “yesterday” relative to the search data and time on the basis of the relationship between the shooting date and time and the search data and time. For place names, representative latitudes and longitudes of cities or countries are stored. For “Red” and “black,” standard average RGB values for red and black, respectively, are stored. For “Car” and “beer,” features of objects are stored. “Feature of object” indicates, for example, “shape of object,” “color of object,” or “relative size of object.” For example, if the object is “car,” “feature of car (object)” indicates information about whether the shape of the car (the profile of the object) is rounded or not, whether the color of the car (the color of the object) is close to a primary color (R, G, or B) or not, and whether the size of the car (the size of the object relative to the face) is large or not. Model can also be used as “feature of car (object).”

It is obvious that the word-image characteristic database DB2 not only contains types of image characteristics, but also contains image characteristic values appropriate to words for the individual types of image characteristics. Examples of values of image characteristic values include representative values, means, minima, maxima, and medians, and they depend on words. As the average RGB values of an object, for example, the average RGB values to be possessed by an object region are stored in association with a word. As maximum brightness, for example, the highest brightness value is selected from brightness values derived from pixel values.

These image characteristic values may be determined by humans on the basis of sensory tests, trial and error, or heuristics, or may be statistically computed from image data items associated with words in advance. For computing, it is possible to retrieve characteristics of image data items associated with words in advance and then store types and values of characteristics typical of the individual words (for example, having a predetermined frequency or more) in the word-image characteristic database DB2.

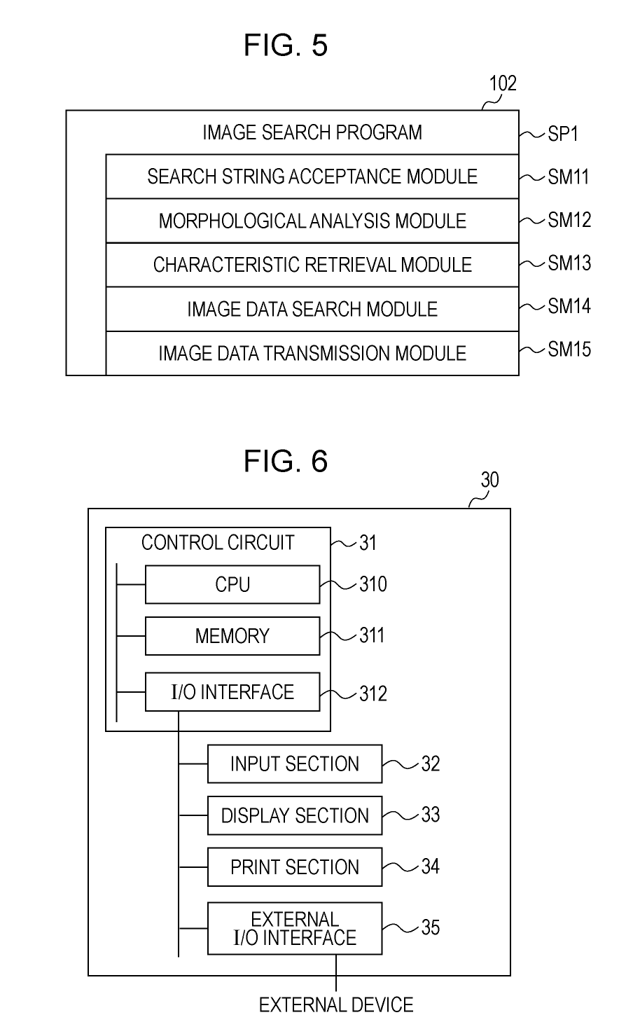

FIG. 5 is a diagram showing a program stored in the memory 102 of the image server 10. The program stored in the memory 102 will be described with reference to FIG. 5. The memory 102 stores an image search program SP1 executed to search the image database DB1 for images in this embodiment.

The image search program SP1 includes a search string acceptance module SM11, a morphological analysis module (word separation module) SM12, a characteristic retrieval module SM13, an image data search module SM14, and an image data transmission module SM15. The search string acceptance module SM11 is executed to accept a search string transmitted from a client computer such as the printer 30 or the personal computer 40. In this embodiment, the term “search string” refers to a significant group of words. The search string used this embodiment is natural text, that is, text in natural, everyday language. Accordingly, the search string acceptance module SM11 has the function of accepting a search string composed of words such as nouns and adjectives. This embodiment can also be applied to image search using strings that are not natural text.

The morphological analysis module SM12 segments the search string accepted by the search string acceptance module SM11 into one or more words on the basis of parts of speech by morphological analysis (word separation). Although the definition of morphological analysis is ambiguous, the term “morphological analysis” as used herein refers to separation of natural text into words, which involves segmenting natural text into words, tagging the segmented words with parts of speech, and processing words not found in a dictionary (unknown words). In general, word segmentation and part-of-speech tagging use a morphological dictionary describing rules for combining adjacent morphemes (words) and morpheme information. The image search program SP1 uses the words, such as nouns and adjectives, obtained by morphological analysis as keywords for the subsequent process. If an image is received from the client computer, such as the printer 30, a string may be extracted and accepted from metadata associated with the received image data item before morphological analysis. The separation of a string into words includes segmenting the string into words and tagging the words with parts of speech by morphological analysis.

The characteristic retrieval module SM13 uses the words obtained by the morphological analysis module SM12 to retrieve corresponding image characteristics from the word-image characteristic database DB2. Specifically, the characteristic retrieval module SM13 retrieves the types and values of the image characteristics corresponding to the obtained words.

The image data search module SM14 searches the image database DB1 using the image characteristics, retrieved by the characteristic retrieval module SM13, corresponding to the words contained in the search string to retrieve corresponding image data items. Specifically, the image data search module SM14 searches the image database DB1 to retrieve image data items associated with image characteristics matching or similar to the retrieved image characteristics. A detailed description of the method for retrieving types and values of image characteristics will be given later.

The image data transmission module SM15 transmits the retrieved image data items to the client computer, such as the printer 30 or the personal computer 40, that transmitted the search string.

When executed by the CPU 101, the search string acceptance module SM11, the morphological analysis module SM12, the characteristic retrieval module SM13, the image data search module SM14, and the image data transmission module SM15 function as a string-accepting section, a word-segmenting section, a characteristic-retrieving section, an image search section, and a retrieved-image-data transmitting section, respectively. Alternatively, the search string acceptance module SM11, the morphological analysis module SM12, the characteristic retrieval module SM13, the image data search module SM14, and the image data transmission module SM15 may be separately implemented by hardware such as semiconductor circuits.

### Configuration of Printer

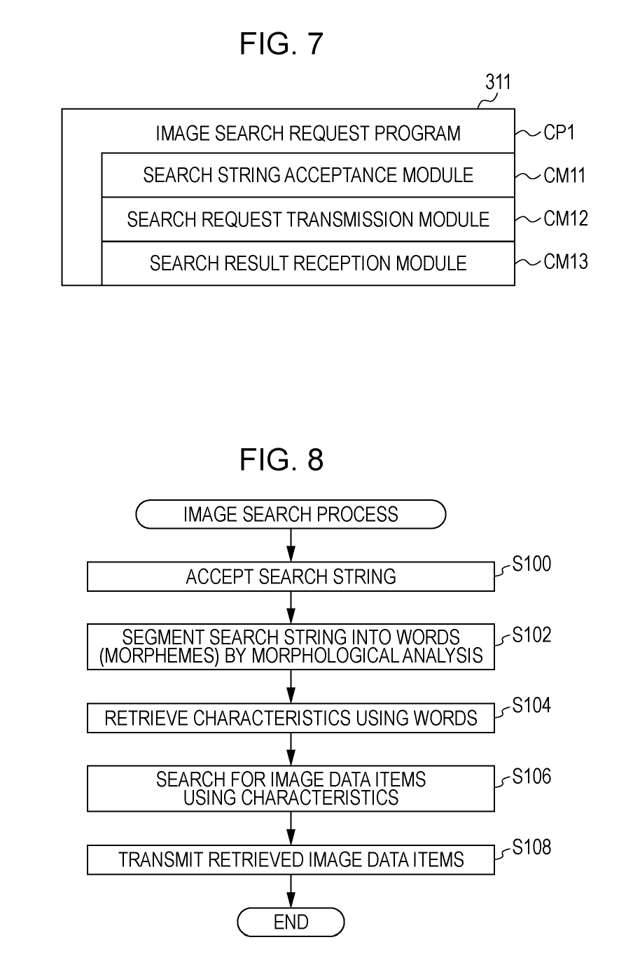

FIG. 6 is a function block diagram schematically showing the internal configuration of the printer 30 in this embodiment. FIG. 7 is a diagram showing a program stored in a memory of the printer 30. Although the printer 30 will be described as an example of an image search terminal in this embodiment, it is obvious that the personal computer 40 can be similarly used as an image search terminal. The printer 30 used in this embodiment can be similarly used in second and third embodiments. The printer 30 includes a control circuit 31, an input section 32, a display section 33, a print section 34, and an external I/O interface 35 that are connected to each other with a signal line. The control circuit 31 includes a CPU 310, a memory 311, and an I/O interface 312 that are connected so as to communicate each other. The CPU 310 executes various programs and modules stored in the memory 311. The memory 311 stores the programs and modules to be executed by the CPU 310 in a nonvolatile manner and has a volatile work space where the programs and modules are loaded when executed by the CPU 310. The memory 311 used may be, for example, a semiconductor storage device such as a read-only memory that stores programs and modules in a nonvolatile manner or a random access memory that provides a volatile work space upon execution of programs and modules, or may be a magnetic hard disk drive or a high-capacity flash memory drive. The I/O interface 312 communicates commands and data between the control circuit 31 and the input section 32, the display section 33, the print section 34, and the external I/O interface 35. The input section 32 is an operating section that allows the user to input a command to the printer 30 and can be implemented by, for example, buttons and wheels. The display section 33 is a color display screen that displays images based on retrieved image data items and various information to the user. The print section 34 executes printing by forming an image on a printing medium according to a print command from the user (control circuit 31). The external I/O interface 35 communicates search requests and results with an external device, for example, the image server 10, according to a known communication protocol.

A program stored in the memory 311 will be described with reference to FIG. 7. The memory 311 stores an image search request program CP1 for requesting the image server 10 for image search. The image search request program CP1 includes a search string acceptance module CM11, a search request transmission module CM12, and a search result reception module CM13. The search string acceptance module CM11 is executed to accept a search string input by the user for specifying images (image data items) to be searched for. The search string acceptance module CM11 may accept a search string input using the input section 32 or may extract and accept character information (string) described in metadata associated with an image data item in advance. Furthermore, the search string acceptance module CM11 may accept both a search string input by the input section 32 and a string described in metadata of an image data item. The search request transmission module CM12 transmits a search request along with the accepted string to the image server 10. The search result reception module CM13 receives one or more image data items as search results from the image server 10. When executed by the CPU 310, the image search request program CP1, the search string acceptance module CM11, the search request transmission module CM12, and the search result reception module CM13 function as an image-search requesting section, a search-string accepting section, a search-request transmitting section, and a search-result receiving section, respectively.

### Image Search Process

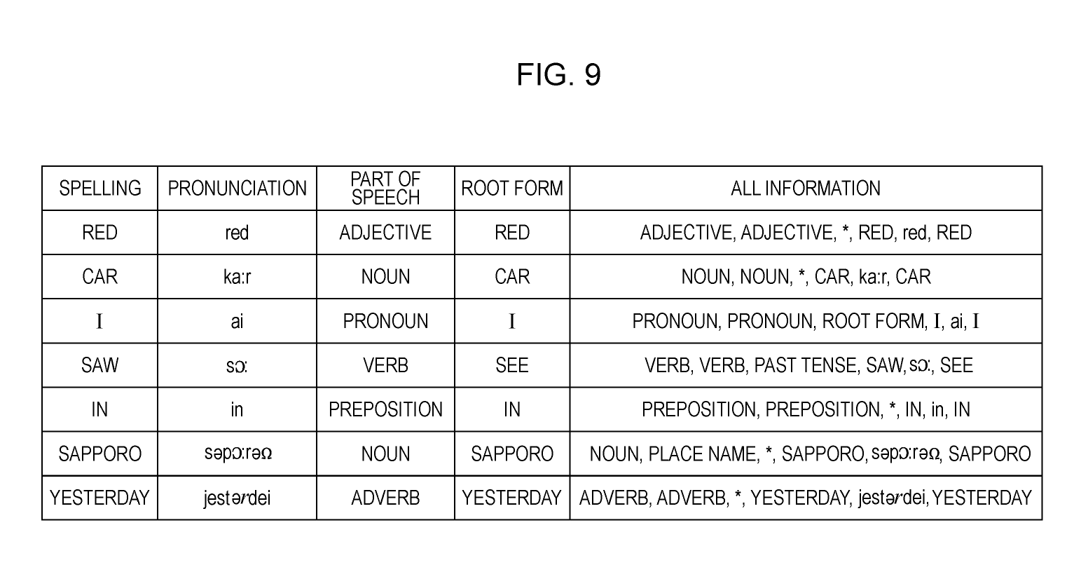

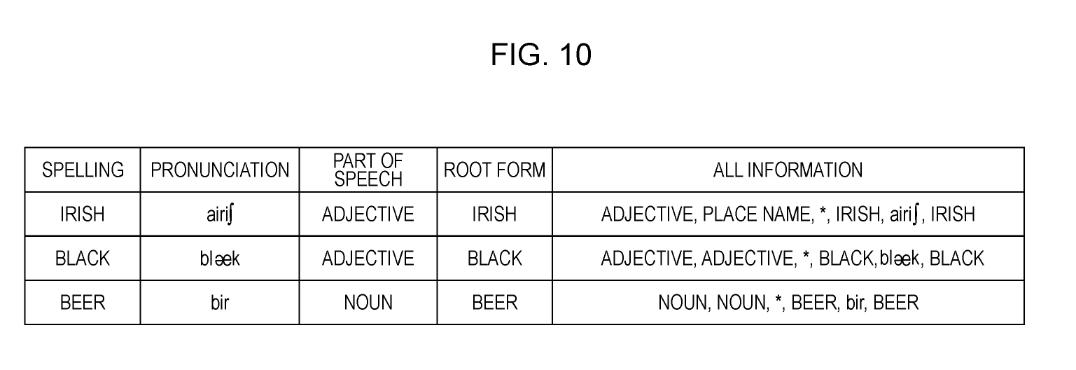

FIG. 8 is a flowchart showing an image search process routine executed by the image server 10 according to this embodiment. FIG. 9 is a table showing a first example of results of morphological analysis. FIG. 10 is a table showing a second example of results of morphological analysis. The image search process is executed by the image server 10 in response to a search request from a search terminal such as the printer 30. When the process routine is started, the search string acceptance module SM11 accepts a string used for search (Step S100). The search string acceptance module SM11 accepts, for example, a search string input by the user using the input section 32 of the printer 30.

After the search string is accepted, the morphological analysis module SM12 separates the string into a plurality of morphemes (words) to obtain words (Step S102). Specifically, the morphological analysis module SM12 separates the string into a plurality of words by morphological analysis. Examples of known methods for selecting a word separation pattern in morphological analysis include a longest match method in which the string is analyzed from the beginning thereof to select the longest word, a least separation method in which a candidate pattern containing the least number of words constituting the original text is selected, a method based on grammatical connectivity between parts of speech, a method based on connection cost between parts of speech, and a method based on a statistical language model. In the longest match method, for example, the longest word entry matching the search string is retrieved from morphemes (word entries) stored in a morphological dictionary and is selected as a candidate for word separation (segmentation). Next, a pointer to the search string is advanced from the beginning position thereof by the string length of the word entry selected as a candidate for word separation, and the next candidate for word separation is selected by the above procedure. It is then determined whether or not the latest word entry selected and the preceding word entry are connectable on the basis of the properties of the two word entries. If the two word entries are connectable, the word segmentation is determined to be correct, and the segmentation and the connection test are repeated to the end of the search string. On the other hand, if the two word entries are unconnectable, the last character of the latest word entry is discarded, and the retrieval of a candidate for word separation and the connection test are executed. If the unconnectable state is repeated, the length of the string used for searching the morphological dictionary may become zero. In this case, the last character of the preceding word entry is discarded because the preceding word entry may be erroneous, and the search of the morphological dictionary and the selection of a candidate for word separation are executed again. Through the above process, the morphological analysis module SM12 segments the string into morphemes (separates the string into words) and determines the properties (parts of speech) of the morphemes.

The words contained in the search string can each be used for retrieval of image characteristics to implement thorough image search and improve search accuracy.

Examples of results of morphological analysis will be described with reference to FIGS. 9 and 10. In the example in FIG. 9, the search string used is “red car I saw in Sapporo yesterday.” As shown in FIG. 9, morphological analysis yields spelling, pronunciation, part of speech, root form, and all information for each segmented word. In the example in FIG. 10, the search string used is “Irish black beer.” As shown in FIG. 10, morphological analysis yields spelling, pronunciation, part of speech, root form, and all information for each segmented word.

After the words are obtained (determined) from the string, the characteristic retrieval module SM13 retrieves corresponding image characteristics from the word-image characteristic database DB2 (Step S104). Specifically, the characteristic retrieval module SM13 retrieves the types and values of the image characteristics corresponding to the obtained words from the word-image characteristic database DB2 shown in FIG. 4.

After the retrieval of the types and values of the image characteristics corresponding to the individual words, the image data search module SM14 searches the image database DB1 for image data items corresponding to the segmented words using the retrieved types and values of the image characteristics (Step S106). Specifically, the image data search module SM14 determines the similarities of the image data items corresponding to the words on the basis of the retrieved types and values of the image characteristics and those associated with the image data items in the image database DB1 to retrieve, as search results, image data items having similarities falling within a predetermined range or equal to or exceeding a predetermined level.

The similarity among the characteristics is determined by, for example, a distance calculation method such as Euclidean distance or Mahalanobis distance. Specifically, the similarity is determined from the distances between the image characteristic values retrieved from the word-image characteristic database DB2 and those associated with the image data items in the image database DB1, that is, the distance between a multidimensional vector of the image characteristic values determined on the basis of the words and a multidimensional vector of those associated with the image data items in the image database DB1. The shorter the distance is, the higher the similarity is determined to be. Alternatively, the similarity may be determined by calculating the inner product of a multidimensional vector containing the image characteristic values determined on the basis of the words and a multidimensional vector containing those associated with the image data items in the image database DB1. In this case, because the difference in cosine between the two multidimensional vectors is calculated, the closer the inner product is to 1 (the closer the angle between the two multidimensional vectors is to 0), the higher the similarity is determined to be.

If the Euclidean distance is used, the similarity can be calculated by equations (1) and (2):

$$\begin{matrix}Similarity = \sqrt{{\sum }_{i = 1}^{n} {ki ( xi - yi )}^{2}} & equation ( 1 ) \\ Similarity = \sqrt{\begin{matrix}\begin{matrix}k 1 {( Shooting date and time )}^{2} + \\ k 2 {( G P S information )}^{2} +\end{matrix} \\ k 3 {( Average R G B values )}^{2}\end{matrix}} & equation ( 2 )\end{matrix}$$

In equation (1), xi is the image characteristic values of the image data items in the image database DB1, yi is the image characteristic values retrieved from the word-image characteristic database DB2, and ki is weighting coefficients (any non-zero values). For ease of understanding, equation (2) explicitly shows that the similarity used is the sum (distance) of the difference determined for each type of characteristic. In the distance-based similarity determination, a calculation result closer to 0 indicates that the image data item has a higher similarity. Accordingly, a higher weighting coefficient may be assigned to a characteristic of higher importance to raise the sensitivity to that characteristic, thus reducing the number of search hits. The similarity used may instead be the simple sum of the similarity calculated for each type of characteristic according to equation (1).

If the inner product is used, on the other hand, the similarity can be calculated according to equation (3), where the coefficients are applied to the components of each multidimensional vector:

$$Similarity = cos θ = \frac{{{g}^{->}}_{R} \cdot {{g}^{->}}_{S}}{\vert {{g}^{->}}_{R} \vert \vert {{g}^{->}}_{S} \vert} = \frac{{k}_{1} {g}_{R 1} {g}_{S 1} + {k}_{2} {g}_{R 2} {g}_{S 2} + … {k}_{n} {g}_{Rn} {g}_{Sn}}{\sqrt{{k}_{1} {g}_{R 1} {g}_{S 1} + {k}_{2} {g}_{R 2} {g}_{R 2} + … {k}_{n} {g}_{Rn} {g}_{Sn}}} \\ {g}^{->} R \text{:} Multidimensional vector of characteristics of image data items in image database D B 1 \\ {g}^{->} S \text{:} Multidimensional vector of characteristics associated with words \qquad equation ( 3 )$$

If the inner product is used as the similarity, an angle between the two multidimensional vectors closer to 0 indicates that the image data item has a higher similarity. Accordingly, a characteristic whose value is equal or similar to those of a plurality of image data items may be more heavily weighted to raise the sensitivity to a characteristic of higher importance, thus refining the search results and improving search accuracy. When the search results are displayed, the similarity calculated during the image data search may be displayed together as a measure of relevance between the string and the search results.

The image data transmission module SM15 transmits the retrieved image data items to the source node of the image data search request, namely, the printer 30 (Step S108), thus completing the process routine. The source node, namely, the printer 30, can be identified, for example, using a source address (IP address or MAC address) contained in the header of the image search request transmitted from the printer 30. In this embodiment, the communication over the network NE follows a known network protocol.

### Image Search Request Process

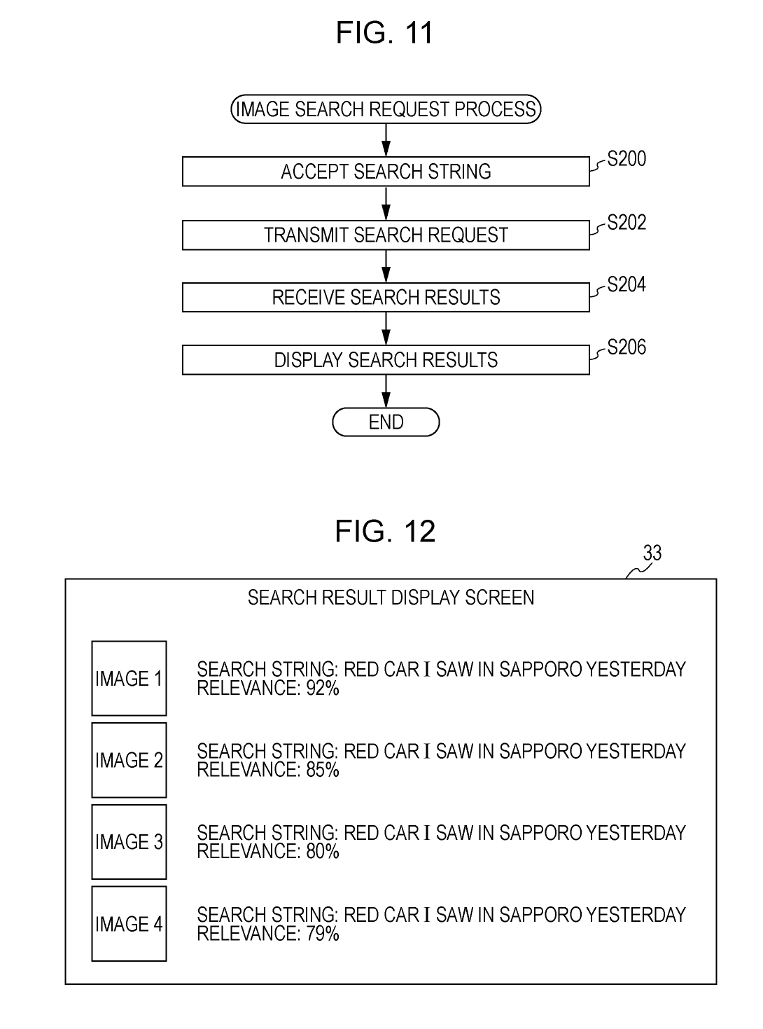

FIG. 11 is a flowchart showing a process routine executed for image search request according to this embodiment. FIG. 12 is a diagram showing an example of an image search result screen displayed on the printer 30 according to this embodiment. This process routine is executed by the printer 30, which serves as an image search terminal. When the process routine is started, the search string acceptance module CM11 of the printer 30 accepts a string of natural text for search (Step S200). Specifically, the search string acceptance module CM11 accepts a string of natural text input by the user using the input section 32 or extracts character information (string) described in metadata associated with an image data item for search in advance.

After the acceptance of the search string, the search request transmission module CM12 transmits a search request to the image server 10 (Step S202). Specifically, the search request transmission module CM12 transmits a search request data array containing the search string and a search request command to the image server 10 via the external I/O interface 35 and the network NE. The search result reception module CM13 receives one or more image data items as search results from the image server 10 (Step S204) and displays images on the display section 33 using the received image data items (Step S206), thus completing the process routine. Instead of, or in addition to, the string, a target image data item designated by the user may be accepted and transmitted. In addition, if a plurality of images are displayed on the display section 33, as shown in FIG. 12, relevance (or similarity) may be displayed on the display section 33 as a measure of relevance between the images and the string of natural text (or target image data item) used for search. The similarity, calculated during the image data search, is difficult to intuitively understand because a higher similarity has a lower value. Accordingly, relevance may instead be used as a measure in percent because it has a higher value for a higher similarity (100% for match). For example, the relevance may be determined by linearly assigning values from 100% to 50% to the range of similarity generally thought to be high (where 100% is assigned to a similarity of 0) while discretely assigning values below 50% to the range of similarity generally thought to be low on the basis of a predetermined rule. Alternatively, the relevance may be determined by, for example, normalizing the reciprocal of the similarity.

In the example in FIG. 12, the search string used is “red car I saw in Sapporo yesterday.” The screen displays relevances based on the similarities between the search string and the retrieved image data items calculated during the search using “red car I saw in Sapporo yesterday” as the search string. If the image search is executed using a plurality of words, or using a target image data item in addition to the words, the relevance calculated on the basis of the highest, lowest, or average similarity associated is displayed. Displaying the retrieved images along with the relevances thereof on the display section 33 allows the user to determine whether the search string used is appropriate or not and, if the search results are unsatisfactory, to execute search again after modifying the search string. The search result reception module CM13 may have the function of a search result display control module, or a search result display control module may be separately provided.

The image server, the image search method, the printer (image search terminal), and the image search system according to the first embodiment described above allow search for image data items on the basis of a string or natural text containing a plurality of words. That is, it is possible to retrieve image characteristics to be used for search from the word-image characteristic database DB2 on the basis of words segmented from a string or natural text to search for image data items using the retrieved image characteristics. This allows image search using conceived natural text without considering search keywords so that the user attains desired search results, thus improving search accuracy.

In the first embodiment, if the string contains a plurality of words, the image search is executed by retrieving image characteristics associated with the individual words so that more types of image characteristics can be used for search, thus improving image search accuracy. If the user inputs two words that are opposite in meaning for image search using a plurality of words, the user can find that the input search string is erroneous because a large number of images are retrieved as search results.

### Second Embodiment

In the first embodiment, natural text is used as a search string, words segmented from natural text are used to retrieve corresponding image characteristics from the word-characteristic database DB2, and image search is executed using the retrieved image characteristics and those of image data items stored in the image database DB1. In the second embodiment, on the other hand, image search is executed on the basis of a combination of a sensitivity word and a noun segmented from natural text.

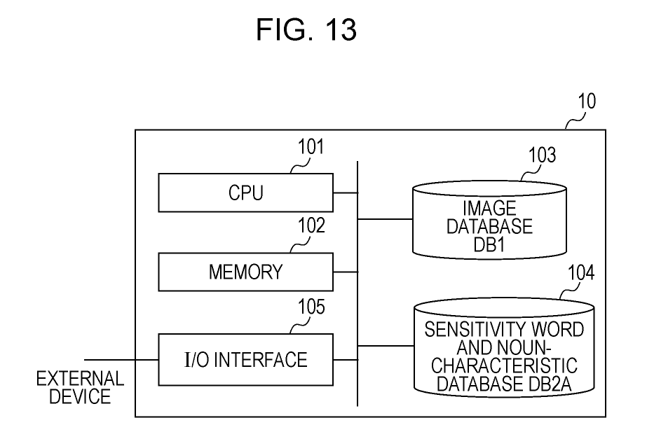

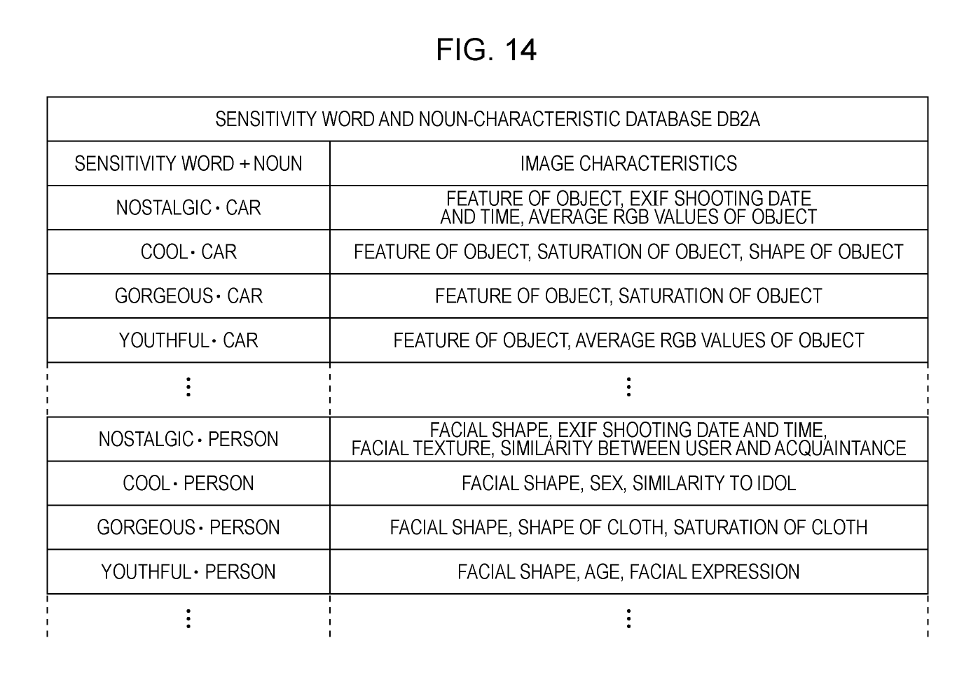

FIG. 13 is a function block diagram schematically showing the internal configuration of an image server according to the second embodiment. FIG. 14 is a table showing an example of a sensitivity word and noun-image characteristic database according to the second embodiment. The sensitivity word and noun-image characteristic database DB2A shown in FIG. 14 is merely illustrative and may contain other combinations of a sensitivity word and a noun and other image characteristics. The image server 10 according to the second embodiment differs from the image server 10 according to the first embodiment in that it includes the sensitivity word and noun-image characteristic database DB2A instead of the word-characteristic database DB2 of the image server 10 according to the first embodiment. The other configuration of the image server 10 according to the second embodiment is similar to that of the image server 10 according to the first embodiment, and accordingly a detailed description thereof will be omitted by using the reference numerals used in the first embodiment.

### Sensitivity Word and Noun-Image Characteristic Database

In this embodiment, the sensitivity word and noun-image characteristic database DB2A is created in the storage device 104 by storing combinations of a sensitivity word and a noun in association with image characteristics and values thereof. In the example in FIG. 14, the sensitivity words used are “nostalgic,” “cool,” “gorgeous,” and “youthful,” and the nouns used in combination with those sensitivity words are “car” and “person.”

Based on the properties of a main subject, the types of image characteristics associated with the nouns “car” and “person” include “feature of object” and “facial shape,” respectively. “Feature of object” indicates, for example, “shape of object,” “color of object,” or “relative size of object.” For example, if the object is “car,” “feature of car (object)” indicates information about whether the shape of the car (the profile of the object) is rounded or not, whether the color of the car (the color of the object) is close to a primary color (R, G, or B) or not, and whether the size of the car (the size of the object relative to the face) is large or not. Model can also be used as “feature of car (object).” “Facial shape” indicates a specific shape corresponding to “face” as “shape of object” and, in a broad sense, can be assumed as a concept included in “shape of object.” As the values of the shape of an object or facial shape, the dimensions (numbers of pixels) in a coordinate system that represent the height and width of an object region to be occupied by an object (main subject) or the face and the average coordinates of the profile are stored in association with a combination of a sensitivity word and a noun.

The sensitivity word “nostalgic” is associated, for both “car” and “person,” with information about the date and time of generation of image data, for example, shooting date and time information contained in Exif information, which is a type of metadata. For example, an image data item generated on a particular date and time ten or twenty years ago can be identified by designating that date and time as the shooting date and time information. The sensitivity word “gorgeous” is associated, for both “car” and “person,” with saturation appropriate as a measure of gorgeousness, generally, high saturation. As is obvious from the example shown in FIG. 14, different combinations of a sensitivity word and a noun are associated with different combinations of image characteristics; the sensitivity word and noun-image characteristic database DB2A is not a database composed only of sensitivity words. That is, the types of image characteristics vary depending on the nouns combined. This avoids or reduces incoherent or unsystematic search results, which is a problem in image search executed on the basis of sensitivity words.

It is obvious that the sensitivity word and noun-image characteristic database DB2A not only contains types of image characteristics, but also contains image characteristic values appropriate to combinations of a sensitivity word and a noun for the individual types of image characteristics. Examples of types of image characteristic values include representative values, means, minima, maxima, and medians, and they depend on combinations of a sensitivity word and a noun. As the average RGB values of an object, for example, the average RGB values to be possessed by an object region are stored in association with a combination of a sensitivity word and a noun. As facial texture, the spatial frequencies to be possessed by a face region are stored in association with a combination of a sensitivity word and a noun. As facial expression, age, and sex, the distances in a coordinate system (differences in coordinate components) and average coordinates to be possessed by organs such as the eyes, the mouth, the nose, and the eyebrows in a face region are stored in association with a combination of a sensitivity word and a noun. As for age and sex, other types of image characteristics may be combined, including the texture, hue, and amount of edge of a face region. As the shape of a cloth, the average dimensions (numbers of pixels) in a coordinate system that represent the height and width of a cloth region are stored in association with a combination of a sensitivity word and a noun. As the saturation of a cloth, the saturation to be possessed by a cloth region is stored in association with a combination of a sensitivity word and a noun. As an image characteristic representing similarity to an idol, the average positions (coordinates) of facial organs of an idol are used. The similarity (closeness) between the user and his or her acquaintance is an image characteristic effective, for example, for personal image databases. As similarity, the values (averages) of positions of facial organs of an acquaintance are used. As closeness, the values (averages) of distances (differences in coordinate components) between the user and his or her acquaintance in an image data item containing the user and his or her acquaintance are used. As for closeness, the values (averages) of positions of facial organs of an acquaintance are preferably stored as an image characteristic of “nostalgic person” to identify the acquaintance.

As facial orientation, the coordinate distance (difference in coordinate components) between the eyes and the mouth in a face region and the coordinate distance between both eyes, the average values to be possessed as coordinate distances representing the sizes of the mouth and the eyes, the average coordinates of the eyes and the mouth in a face region, or the average tilt angles of the face in vertical and horizontal directions are stored in association with a combination of a sensitivity word and a noun. As hue, saturation, and value, generally, H (hue), S (saturation), and V (value) in the HSV color space are stored.

As Exif information, in addition to shooting date and time, GPS information for identifying a shooting place or shooting mode information for identifying a shooting scene such as a night scene, a landscape, or a portrait can be stored as an image characteristic in association with a combination of a sensitivity word and a noun.

These image characteristic values may be determined by humans on the basis of sensory tests, trial and error, or heuristics, or may be statistically computed from image data items associated with combinations of a sensitivity word and a noun in advance. For computing, it is possible to retrieve characteristics of image data items associated with combinations of a sensitivity word and a noun in advance and then store types and values of characteristics typical of the individual combinations of a sensitivity word and a noun (for example, having a predetermined frequency or more) in the sensitivity word and noun-image characteristic database DB2A.

It is obvious that the separation of a combination of a sensitivity word and a noun is executed by the morphological analysis module SM12 in the image server 10. The characteristic retrieval module SM13 retrieves corresponding image characteristics from the sensitivity word and noun-image characteristic database DB2A using a sensitivity word and a noun retrieved by morphological analysis. Specifically, the characteristic retrieval module SM13 retrieves the types and values of the image characteristics corresponding to the retrieved combination of a sensitivity word and a noun.

The image data search module SM14 searches the image database DB1 using the image characteristics, retrieved by the characteristic retrieval module SM13, corresponding to the combination of a sensitivity word and a noun contained in the search string to retrieve corresponding image data items. Specifically, the image data search module SM14 searches the image database DB1 to retrieve image data items associated with image characteristics matching or similar to the retrieved image characteristics. The method for retrieving types and values of image characteristics will be discussed in detail along with the third image search process.

The image server 10 may include an image data acceptance module that accepts an image data item transmitted from the client computer, such as the printer 30 or the personal computer 40, along with or instead of a search string. In addition, the image server 10 may include a characteristic extraction module that extracts image characteristics of an image data item transmitted along with a search string. Examples of types of image characteristics extracted include the same types of image characteristics as those associated with image data items in the image database DB1 and commonly used image characteristics such as hue, saturation, value, average brightness, and amount of edge. Furthermore, the image server 10 may include a string search module that searches for character information (string) for search instead of a search string from an image data item transmitted from, for example, the printer 30. The string search module extracts a string from metadata associated with the image data item. The extracted string preferably contains a combination of a sensitivity word and a noun, and accordingly the string search module may extract only a string containing a combination of a sensitivity word and a noun by the morphological analysis described above. If the extracted string does not contain a combination of a sensitivity word and a noun, a request for character input of a string containing a sensitivity word and a noun may be transmitted to, for example, the printer 30. Alternatively, instead of image search using a combination of a sensitivity word and a noun, image search based on image characteristics may be executed by extracting image characteristics from the image data item.

When executed by the CPU 101, the image data acceptance module, the characteristic extraction module, and the string search module function as an image-accepting section, a characteristic-extracting section, and a string search section, respectively. Alternatively, the image data acceptance module, the characteristic extraction module, and the string search module may be separately implemented by hardware such as semiconductor circuits.

### First Image Search Process

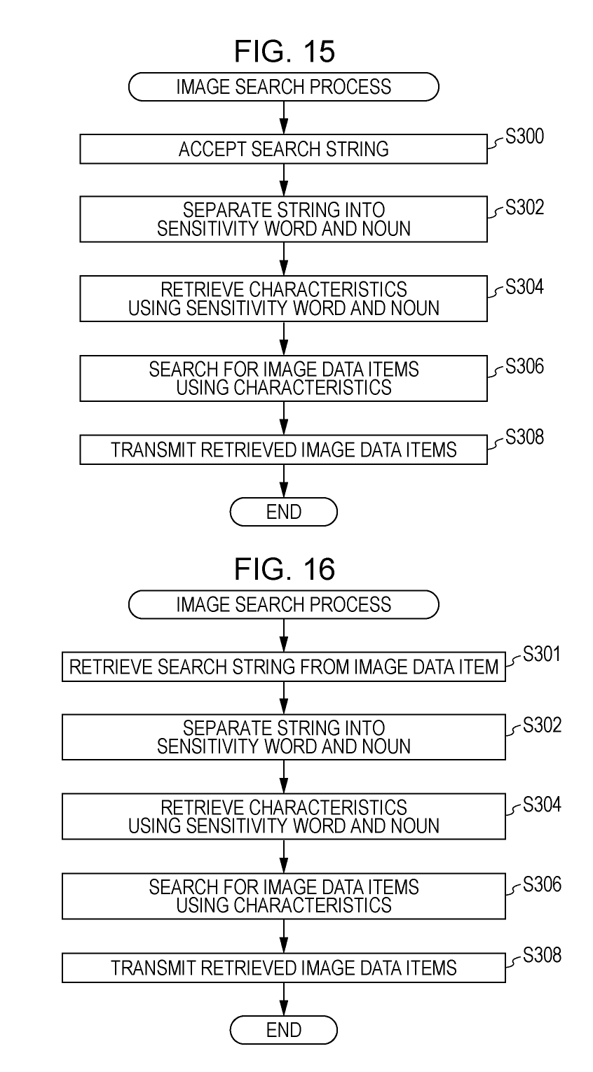

FIG. 15 is a flowchart showing a first image search process routine executed by the image server 10 according to the second embodiment. The image server 10 executes the image search process in response to a search request from a search terminal such as the printer 30. When the process routine is started, the search string acceptance module SM11 accepts a string used for search (Step S300). The search string acceptance module SM11 accepts, for example, a search string input by the user using the input section 32 of the printer 30.

After the search string is accepted, the morphological analysis module SM12 separates the string into a sensitivity word and a noun (Step S302). Specifically, the morphological analysis module SM12 separates the string into a sensitivity word and a noun by morphological analysis. The method for selecting a word separation pattern in morphological analysis is as described in the first embodiment, and accordingly a description thereof will be omitted.

The search string preferably contains only a sensitivity word and a noun; however, even if other parts of speech are contained, the words contained in the string can be tagged with parts of speech by the morphological analysis described above. In addition, the string may contain a plurality of combinations of a sensitivity word and a noun, for example, a plurality of sensitivity words. If the string contains a plurality of combinations of a sensitivity word and a noun, each possible combination of a sensitivity word and a noun can be used for retrieval of image characteristics to implement thorough image search and improve search accuracy.

After the combination of a sensitivity word and a noun is obtained (determined) from the string, the characteristic retrieval module SM13 retrieves corresponding image characteristics from the sensitivity word and noun-image characteristic database DB2A (Step S304). Specifically, the characteristic retrieval module SM13 retrieves the types and values of corresponding image characteristics from the sensitivity word and noun-image characteristic database DB2A shown in FIG. 14 using the combination of a sensitivity word and a noun as a search key.

After the retrieval of the types and values of the image characteristics corresponding to the combination of a sensitivity word and a noun, the image data search module SM14 searches the image database DB1 for image data items corresponding to the combination of a sensitivity word and a noun using the retrieved types and values of the image characteristics (Step S306). Specifically, the image data search module SM14 determines the similarities of the image data items corresponding to the combination of a sensitivity word and a noun on the basis of the retrieved types and values of the image characteristics and those associated with the image data items in the image database DB1 to retrieve, as search results, image data items having similarities falling within a predetermined range or equal to or exceeding a predetermined level.

The determination of the similarity among the characteristics is as described in the first embodiment, and accordingly a description thereof will be omitted. The image data transmission module SM15 transmits the retrieved image data items to the source node of the image data search request, namely, the printer 30 (Step S308), thus completing the process routine. The source node, namely, the printer 30, can be identified, for example, using a source address (IP address or MAC address) contained in the header of the image search request transmitted from the printer 30. In this embodiment, the communication over the network NE follows a known network protocol.

### Second Image Search Process

FIG. 16 is a flowchart showing a second image search process routine executed by the image server 10 according to the second embodiment. The second image search process differs from the first image search process in that the search string used is not a string transmitted from, for example, the printer 30, but a string extracted from an image data item transmitted from, for example, the printer 30. Accordingly, a detailed description of the same process steps as those of the first image search process will be omitted by assigning the same step numbers as those used in the first image search process. The following description will focus on process steps different from those of the first image search process.

When the process routine is started, the string search module retrieves a string used for search from an image data item transmitted from the printer 30 (Step S301). Specifically, the string search module retrieves a string described in metadata associated with the image data item transmitted from the printer 30. The term “metadata” herein refers to information, associated with an image data item, about the content, properties, etc. of the image data item. The metadata is associated with the image data item in a format such as a tag or a header.

After the string is retrieved, as in the case where a string is transmitted from the printer 30, the image server 10 separates the string into a sensitivity word and a noun (Step S302) and retrieves one or more corresponding image characteristics from the sensitivity word and noun-image characteristic database DB2A on the basis of the combination of a sensitivity word and a noun obtained by separation (Step S304). The image server 10 then searches the image database DB1 for image data items with high similarity using the retrieved image characteristics (Step S306) and transmits the retrieved image data items to the printer 30 (Step S308), thus completing the process routine. Steps S302 to S306 are executed as in the first image search process, and accordingly a detailed description thereof will be omitted.

### Third Image Search Process

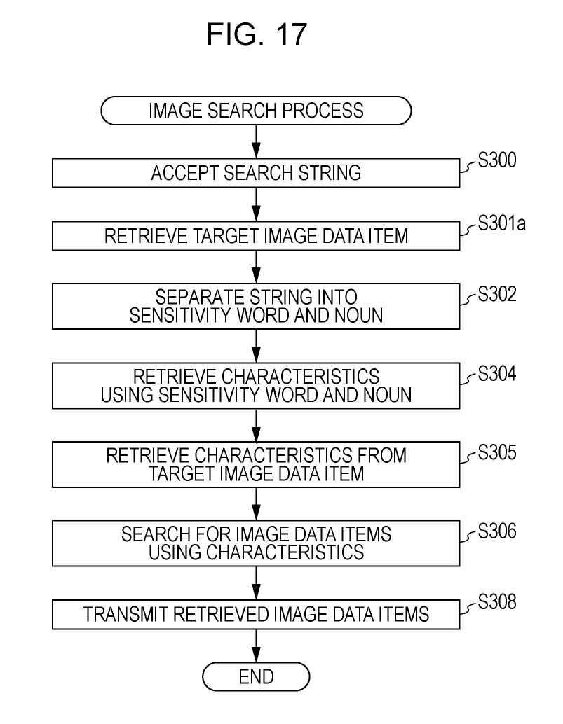

FIG. 17 is a flowchart showing a third image search process routine executed by the image server 10 according to the second embodiment. The third image search process differs from the first image search process in that a string is transmitted from, for example, the printer 30 as a search string together with an image data item serving as a search target (key). Accordingly, a detailed description of the same process steps as those of the first image search process will be omitted by assigning the same step numbers as those used in the first image search process. The following description will focus on process steps different from those of the first image search process.

When the process routine is started, the search string acceptance module SM11 accepts a string used for search (Step S300), and the image data acceptance module accepts a target image data item serving as a search key from the printer 30 (S301a). That is, in the third image search process, an image data item of a target image that the user wishes to search for as a search key is transmitted in addition to the search string from the printer 30 to the image server 10.

After the search string and the target image data item are accepted, the image server 10 separates the string into a sensitivity word and a noun (Step S302) and retrieves one or more corresponding image characteristics from the sensitivity word and noun-image characteristic database DB2A on the basis of the combination of a sensitivity word and a noun obtained by separation (Step S304).

The characteristic extraction module of the image server 10 extracts image characteristics from the accepted target image data item (Step S305). Examples of types of image characteristics extracted and retrieved from the target image data item include the average brightness, minimum brightness, and maximum brightness of the image data item; the hues, saturations, and values of representative colors; the proportions of the representative colors in the image; the shape, size, texture, orientation, and expression of a face contained in the image data item; the amount and orientation of edge; the features and shape of an object; the sex, age, and expression based on a face region; similarity to an idol; the shape and saturation of a cloth; and similarity (closeness) between the user and his or her acquaintance. When such image characteristics are extracted, the values thereof are determined as described below, where RGB dot matrix data will be taken as an example of the image data item. The values of the individual image characteristics are determined using all pixel data items constituting the image data item or pixel data items (sampling pixel data items) left after decimating a predetermined number of pixel data items from the image data item. For example, the frequency distributions (histograms) of R, G, and B components are obtained by determining the R, G, and B component values (ranging from 0 to 255 for 8-bit gradation) of all pixel data items constituting the image data item and then plotting the R, G, and B component values on a graph having R, G, and B component values (also referred to as gradation values) as its horizontal axis and frequency as its vertical axis. A brightness histogram is obtained by converting the R, G, and B component values into Y component values (brightness component values) using a known conversion formula and then plotting the Y component values obtained by conversion on a graph having Y component values (also referred to as gradation values) as its horizontal axis and frequency as its vertical axis. The average brightness is determined by dividing the sum of the Y component values of all pixel data items by the number of pixel data items. The minimum or maximum brightness is determined by identifying the minimum or maximum brightness value in the brightness histogram. For example, if the saturation of an object or cloth is needed, the pixel data items constituting the object (or cloth) may be subjected to the above process after identifying the object, as described later.

The hues, saturations, and values of representative colors may be determined by converting the RGB values of the image data item or a decimated image data item into HSV values, creating a histogram having HSV component values as its horizontal axis and frequency as its vertical axis using the H (hue), S (saturation), and V (value) obtained by conversion, and identifying hues, saturations, and values having the highest frequencies as the hues, saturations, and values of representative colors. The process of conversion from the RGB color space into the HSV color space is widely known, and accordingly a detailed description thereof will be omitted.

As the amount and direction of edge, the amount and angle of edge can be calculated, for example, using a known 3×3 Prewitt operator or 5×5 Prewitt operator.

The region (face region) of an object (main subject) can be defined by dividing the pixels constituting the image into groups of adjacent pixels having similar pixel values, for example, similar RGB component values, or groups of pixels belonging to a predetermined range of hue (generally, skin colors for face regions). In addition, setting an X-Y coordinate system over the entire image allows the position, shape, and size of an object in an image to be determined on the basis of coordinates (coordinate components). That is, coordinates (coordinate components) are retrieved as image characteristic values for the position, shape, and size of an object. The positions of organs such as the eyes, the mouth, and the nose in a face region can also be determined by obtaining coordinates and coordinate distances after edge detection. With this assumption, the coordinate distances of the width and height of a defined face region are determined as the size and shape of the face. As facial orientation, the coordinate distance between the eyes and the mouth in a face region, the coordinate distance between both eyes, and the coordinate distances representing the sizes of the mouth and the eyes are retrieved. Specifically, the coordinate distance between the eyes and the mouth, the coordinate distance between both eyes, and the coordinate distances representing the sizes of the mouth and the eyes in a face region in frontal view are determined in advance as reference values. For example, a defined face region can be determined to be an upward face image if the coordinate distance between the eyes and the mouth is smaller than the reference value thereof and the size of the mouth is larger than the reference value thereof, and can be determined to be a leftward face image if the coordinate distance between the eyes and the mouth is equivalent to the reference value thereof, the coordinate distance between both eyes is smaller than the reference value thereof, and the size of the right eye is larger than the reference value thereof. In addition, the tilt angles of the face in vertical and horizontal directions can be determined by associating, in advance, differences between the coordinate distance between the eyes and the mouth, the coordinate distance between both eyes, and the coordinate distances representing the sizes of the mouth and the eyes in a defined face region and the respective reference values thereof, with the angles of the face.

As facial shape, facial expression, and sex and age based on the face, the coordinate components of the profile and organs of the face are retrieved. The facial shape, the facial expression, and the sex and age based on the face can be determined by comparing the coordinate components of the organs obtained by image analysis with coordinate components associated with facial expressions showing various emotions, ages, and sexes in advance (values stored in the sensitivity word and noun-image characteristic database DB2A). The texture of a face region can be determined by frequency analysis of a defined face region. The frequency analysis of a defined face region is executed by determining the frequencies of the pixel data items constituting the defined face region by two-dimensional Fourier transform. In general, a high proportion of low-frequency component in the resultant frequency components indicates that the image is smooth, whereas a high proportion of high-frequency component in the resultant frequency components indicates that the image is not smooth.

A feature of an object is retrieved by, for example, determining “shape of object,” “color of object,” or “relative size of object” described above. Specifically, for example, “shape of object” can be retrieved from a profile (edge) extracted from an image by a known technique. “Color of object” can be retrieved from the RGB values of an image region surrounded by the profile, or can be retrieved from the RGB values at and around the in-focus position using in-focus position information associated with the image. If the image has an image region recognized as the face, “relative size of object” can be retrieved by comparing the size of the face image region with that of the image region surrounded by the profile. As an image characteristic representing similarity to an idol, the positions (coordinate components) of facial organs are retrieved. As similarity (closeness) between the user and his or her acquaintance, the positions of facial organs of an object are retrieved. As closeness, the distance (coordinate components) between the user and his or her acquaintance in an image data item containing the user and his or her acquaintance is retrieved.

Exif shooting date and time information can be retrieved from an Exif tag, which is metadata associated with an image data item. That is, the term “retrieval of image characteristics” in this embodiment is a concept encompassing retrieving the component values of pixel data items from an image data item composed of pixel data items, retrieving statistical values by statistically processing the retrieved component values, and retrieving image information from metadata associated with an image data item.

The image server 10 searches the image database DB1 for image data items with high similarity using the image characteristics retrieved from the sensitivity word and noun-image characteristic database DB2A on the basis of the string and the image characteristics extracted from the target image data item (Step S306). In the search for image data items, similarity can be calculated as in the first image search process using the image characteristics retrieved from the sensitivity word and noun-image characteristic database DB2A and the image characteristics extracted from the target image data item. That is, the values of the image characteristics retrieved from the sensitivity word and noun-image characteristic database DB2A and the values of the image characteristics extracted from the target image data item may be used for the parameter yi in equation (1). For overlapping types of image characteristics, it is possible either to use all of the values of the image characteristics retrieved from the sensitivity word and noun-image characteristic database DB2A and the values of the image characteristics extracted from the target image data item or to preferentially use the values of the image characteristics extracted from the target image data item. If all image characteristic values are used irrespective of overlap in the types of image characteristics, the search accuracy can be improved. On the other hand, if the values of the image characteristics extracted from the target image data item are preferentially used, image search based on the characteristics of the image data item selected as a search key by the user can be executed to provide search results as intended by the user. Preferentially using the values of the image characteristics extracted from the target image data item means, for overlapping types of image characteristics, using only the values of the image characteristics extracted from the target image data item or multiplying the values of the image characteristics extracted from the target image data item by a weighting coefficient so that they are more heavily weighted.

The image server 10 transmits the retrieved image data items to the printer 30 (Step S308), thus completing the process routine. Steps S302, S304, and S308 are executed as in the first image search process, and accordingly a detailed description thereof will be omitted.

The image server, the image search method, the printer (image search terminal), and the image search system according to the second embodiment described above allow search for image data items using a combination of a sensitivity word and a noun as a search key. That is, it is possible to retrieve image characteristics to be used for search from the sensitivity word and noun-image characteristic database DB2A on the basis of a combination of a sensitivity word and a noun to search for image data items using the retrieved image characteristics. This avoids or reduces incoherent or unsystematic search results, which is a problem in image search technology based only on sensitivity words. That is, it is possible to systematize search targets using a combination of a sensitivity word and a noun as a search key, thus providing coherent search results. In addition, it is possible to allow the user to attain desired search results, thus improving search accuracy.

In the second image search process, additionally, image search is executed by retrieving or extracting a search string from an image data item selected by the user, thus providing search results reflecting the user's intention without the need for input of a search string.

In the third image search process, additionally, image search is executed using image characteristics of an image data item selected by the user in addition to a search string input by the user, thus providing search results reflecting the user's intention that cannot be expressed only by a search string. That is, it is possible to execute image search based on image characteristics possessed by an image data item selected by the user, thus further improving search accuracy in image search using a search string.

In the image search processes according to this embodiment, if either a plurality of sensitivity words or a plurality of nouns are used, image search is executed by retrieving image characteristics associated with the individual combinations of a sensitivity word and a noun words so that more types of image characteristics can be used for search, thus improving image search accuracy. If the user inputs two sensitivity words that are opposite in meaning for image search using a plurality of sensitivity words, the user can find that the input search string is erroneous because a large number of images are retrieved as search results.

### Third Embodiment

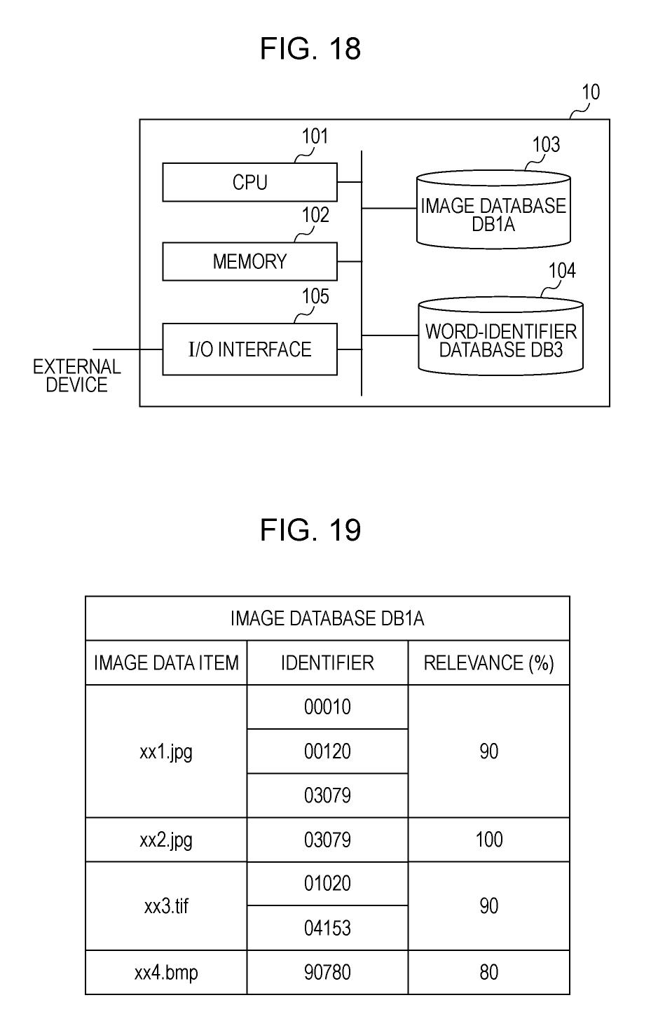

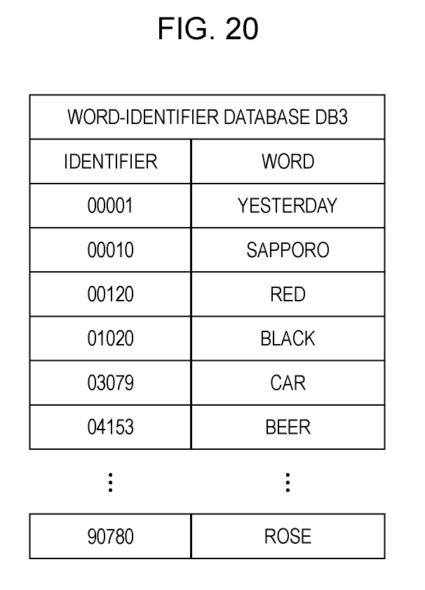

FIG. 18 is a function block diagram schematically showing the internal configuration of an image server according to the third embodiment. FIG. 19 is a table showing an example of an image database according to the third embodiment. FIG. 20 is a table showing an example of a word-identifier database according to the third embodiment. As shown in FIG. 18, an image server 10 according to the third embodiment differs from the image server 10 according to the first embodiment in that it includes a word-identifier database DB3 instead of the word-characteristic database DB2 included in the image server 10 according to the first embodiment and an image database DB1A instead of the image database DB1. The other configuration of the image server 10 according to the third embodiment is similar to that of the image server 10 according to the first embodiment, and accordingly a detailed description thereof will be omitted by using the reference numerals used in the first embodiment.

In the first embodiment, image search is executed using image characteristics associated with words segmented from natural text and those associated with image data items stored in the image database DB1. In the third embodiment, on the other hand, image search is executed by searching the image database DB1A, which is created in advance by associating image data items with identifiers, using identifiers, associated with words segmented from natural text, retrieved from the word-identifier database DB3. This can be assumed as image search indirectly using image characteristics because the image database DB1A is created by assigning identifiers on the basis of image characteristics of target image data items. In addition, it is obvious that this embodiment can be applied to the second embodiment, that is, image search using a combination of a sensitivity word and a noun.

### Image Database

In this embodiment, as shown in FIG. 19, the image database DB1A is created in the storage device 103 by storing image data items in association with unique identifiers and relevance. The image database DB1A differs from the image database DB1 in the first embodiment in that the image data items are associated with identifiers and optionally relevance instead of image characteristics, although they are similar in that they contain a plurality of image data items. The relevance, as described above, is a measure of the strength, based on similarity, of the relationship between an identifier or word (keyword) and an image data item. In this embodiment, corresponding image data items can be immediately retrieved by identifying their identifiers without the need for similarity determination using characteristics of segmented words or an image. In addition, the similarities of the image data items for the individual identifiers can be obtained without calculation because they are associated in advance. The image database DB1A is implemented by, for example, a management table that associates image data items with identifiers and similarity, although the similarity does not have to be associated. A string of natural text often contains a plurality of words expressing an image; therefore, as shown in FIG. 19, an image data item can be associated with a plurality of identifiers (corresponding to the word).

The image database DB1A is created using an identifier-characteristic-word database that associates identifiers with image characteristics and words. That is, the image database DB1A is created by extracting one or more image characteristics from a target image data item to be added to the image database DB1A, determining the similarity between the extracted image characteristics and database image characteristics stored in the identifier-characteristic-word database, and associating the target image data item with an identifier associated with a database image characteristic having the highest similarity. The method for extracting and retrieving image characteristics and the method for determining similarity are as described above, and accordingly a description thereof will be omitted. To create the identifier-characteristic-word database used for creating the image database DB1A, the values of image characteristics corresponding to words may be determined by human sensitivity on the basis of sensory tests, trial and error, or heuristics, or may be statistically computed from image data items associated with words in advance. For computing, it is possible to retrieve characteristics of image data items associated with words in advance and then store types and values of characteristics typical of the individual words (for example, having a predetermined frequency or more) in the identifier-characteristic-word database.

### Word-Identifier Database

As shown in FIG. 20, the word-identifier database DB3 associates words with unique identifiers. The association of words with identifiers follows the correspondences between words and identifiers in the identifier-characteristic-word database, used for creating the image database DB1A, that associates identifiers with image characteristics and words. In the example in FIG. 20, the individual words are associated with unique identifiers.

### Image Search Process

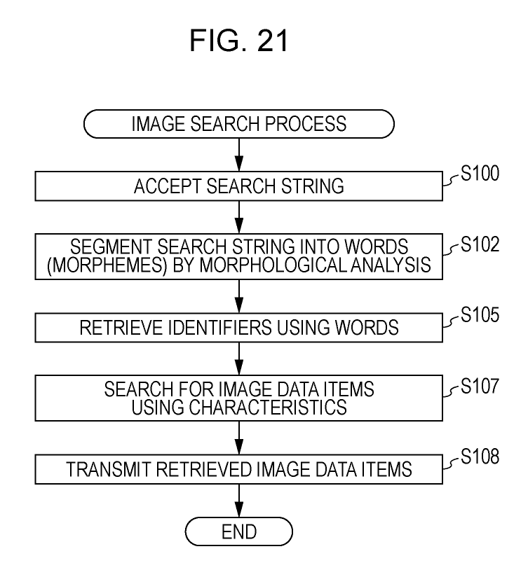

FIG. 21 is a flowchart showing a process routine executed for image search according to the third embodiment. The image search process in this embodiment differs from the image search process in the first embodiment in that identifiers are used to search for image data items. Accordingly, a detailed description of the same process steps as those of the image search process in the first embodiment will be omitted by assigning the same step numbers as those used in the image search process in the first embodiment. The following description will focus on process steps different from those of the image search process in the first embodiment.

The image search process in this embodiment is executed by the image server 10 in response to a search request from a search terminal such as the printer 30. When the process routine is started, the search string acceptance module SM11 accepts a string used for search (Step S100). The search string acceptance module SM11 accepts, for example, a search string input by the user using the input section 32 of the printer 30.

After the search string is accepted, the morphological analysis module SM12 separates the string into a plurality of morphemes (words) to obtain words for search (Step S102). After the words serving as search keywords are obtained, an identifier retrieval module searches the word-identifier database DB3 to retrieve identifiers corresponding to the obtained words (Step S105). Specifically, the identifier retrieval module searches a list of words contained in the word-identifier database DB3 for identifiers associated with words matching the words used for search. Because natural text is used as the search string in this embodiment, a plurality of identifiers corresponding to the individual words can be retrieved by one image search process.

Preferably, the word-identifier database DB3 and the identifier-characteristic-word database are regularly synchronized. If the correspondences between identifiers and words in the word-identifier database DB3 do not correspond to those in the identifier-characteristic-word database, it is impossible to retrieve appropriate identifiers on the basis of words, thus decreasing the image search accuracy. Alternatively, the word-identifier database DB3 and the identifier-characteristic-word database may be created as the same database. That is, a single database that associates identifiers with image characteristics and words (word groups) may be used. This database can be used as a characteristic-identifier(-word) database for creating the image database DB1A. This eliminates the need for synchronization of the content thereof with the content of the word-identifier database DB3 used for image search and simplifies the configuration of the device for creating the image database DB1A.

After the identifiers are retrieved, the image data search module SM14 searches the image database DB1A for image data items using the retrieved identifiers (Step S107). That is, in this embodiment, the image data search module SM14 searches the image database DB1A for image data items using the retrieved identifiers without similarity determination using characteristics of image data items. Because a plurality of identifiers are retrieved in this embodiment, as described above, the image data search module SM14 searches the image database DB1A for image data items associated with the identifiers corresponding to the individual identifiers. In the search for image data items, it is possible to set different priorities for the identifiers associated with the words serving as keys to preferentially (selectively) search for image data items associated with an identifier having a higher priority. It is also possible to search for image data items associated with more identifiers retrieved or to search for image data items associated with more identifiers including an identifier having a higher priority.

In this embodiment, the retrieved image data items are associated with similarities for identifiers. The image data search module SM14 can therefore quickly search the image database DB1A for image data items and retrieve similarities between the retrieved image data items and the keywords.

The image data transmission module SM15 transmits the retrieved image data items to the source node of the image data search request, namely, the printer 30 (Step S108), thus completing the process routine. The source node, namely, the printer 30, can be identified, for example, using a source address (IP address or MAC address) contained in the header of the image search request transmitted from the printer 30. In this embodiment, the communication over the network NE follows a known network protocol.

The image search apparatus (image server), the image search method, the printer (image search terminal), and the image search system according to the third embodiment described above allow image data items to be retrieved on the basis of identifiers from the image database DB1A storing image data items in association with identifiers. That is, it is possible to search for image data items without the need for extraction of characteristics from target image data items and the image data items to be searched for and calculation of similarity using characteristics of the image data items.

In this embodiment, additionally, it is possible to retrieve identifiers associated with words in advance to search for image data items using the retrieved identifiers, thus further improving the speed and accuracy of search for image data items. That is, it is possible to search for image data items without the need for extraction of image characteristics and calculation of similarity. In addition, it is possible to search for image data items appropriate to natural text serving as a search string using a plurality of identifiers corresponding to the individual words. This allows quick and accurate search for image data items.

### Another Example of Word-Identifier Database DB3

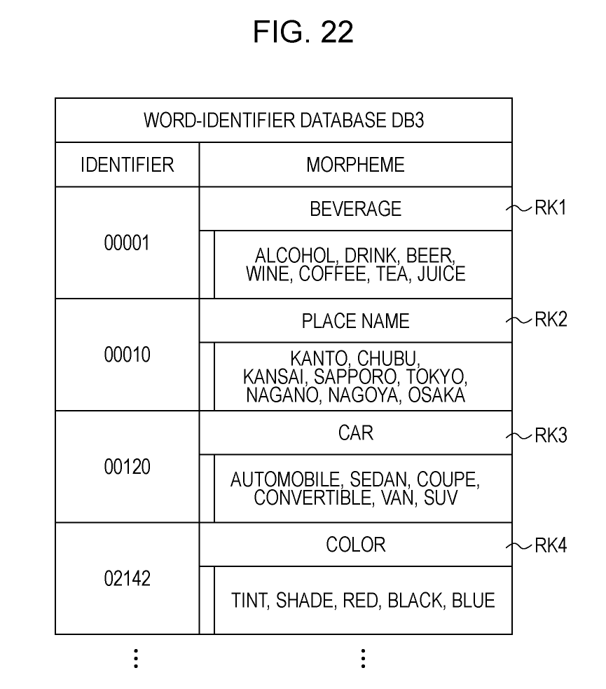

FIG. 22 is a table showing another example of the word-identifier database DB3 in the third embodiment. A word-identifier database DB3A shown in FIG. 22 differs from the word-identifier database DB3 in that each identifier is associated with a plurality of words constituting the same concept. That is, sets of words are handled as word groups belonging to superordinate concepts, namely, representative words RK1 to RK4, and the identifiers are associated with the representative words RK1 to RK4. Preferably, the word groups belonging to the representative words RK1 to RK4 are hierarchically organized so that superordinate words (such as “drink”) are followed by specific words (such as “juice”).

Thus, the use of a database that associates each identifier with a word group hierarchically including a plurality of words as the word-identifier database DB3A used for image search allows matching identifiers to be accurately retrieved even if the string input by the user varies in expression or contains a synonym of another word. That is, it is possible to deal with abstract words because the word groups hierarchically include words, from superordinate concepts to subordinate concepts, and to deal with expressions varying depending on users because the word groups include synonyms and related words. As a result, the image server 10 can search for images using identifiers without searching a synonym database for taking varying expressions and synonyms into account.

In addition, the identifier-characteristic-word database used for creating the image database DB1A associates each identifier with a plurality of characteristics (many image data items). This allows more image data items to be quickly and accurately retrieved as compared with the comparison between a target image data item and the image data items to be searched for.

Furthermore, it is possible to deal with a new candidate word by updating the list of the corresponding word group (that is, adding it to the corresponding word group) without the need for adding a new identifier or changing the identifiers. This facilitates maintenance of the word-identifier database DB3A and the characteristic-identifier database. In this example, additionally, different databases, which generally use their own keywords, can be integrated while maintaining their own keywords by associating them with common identifiers. This allows integration of databases without, for example, changing or updating keywords. In addition, the image search terminal, namely, the printer 30, may transmit only a search string to the image server 10 without adding additional information, such as synonyms, to the search string. This avoids or reduces a decrease in search accuracy due to varying search strings and an increase in image search time due to varying search strings.

### VARIATIONS

(1) Whereas the printer 30 has been taken as an example of an image search terminal in the embodiments described above, the personal computer 40 can be similarly used. The personal computer 40 includes the display 41 and the input devices (such as a keyboard and a mouse) 42.

(2) Whereas the image server 10 retrieves a search string from an image data item transmitted from the image search terminal, namely, the printer 30, in the second image search process of the second embodiment, the printer 30 may retrieve a search string from metadata associated with an image data item and transmit the retrieved string to the image server 10. In this case, the image server 10 executes the same processing as in the first image search process of the second embodiment.

(3) Whereas the image search process has been described in the above embodiments by taking a server computer that searches an image database in response to a request from a client as an example of the image server 10, the image search process may instead be executed by the printer 30 or the personal computer 40. For example, the image data search may be executed on a local image database stored in a storage device of the personal computer 40. If the printer 30 has a high-capacity storage drive, the above image search method may be applied to local image data search in the printer 30. That is, the image server may be implemented as one of the functions of a standalone personal computer or printer that is not connected to a network, a computer program, or a computer-readable medium storing a computer program. This provides convenience of image data search for personal use, including improved search speed and accuracy and easier search. Examples of computer-readable media include various recording media such as CDs, DVDs, hard disk drives, and flash memories.

(4) Whereas image search has been taken as an example in the above embodiments, they can also be applied to other types of content, including video, music, games, and electronic books. For video, characteristics can be retrieved in the same manner as image characteristics, and a string can be extracted from metadata. For music, characteristics can be retrieved by tone detection technology, and a string can be extracted from metadata. For games, a string can be retrieved from, for example, metadata. For electronic books, characteristics can be retrieved by analyzing frequently occurring words.

(5) Whereas the printer 30 processes the search results received from the image server 10 for display to display them on the display section 33 in the above embodiments, the image server 10 may instead create search result data for display and transmit it to the printer 30. The search result data received from the image server 10 can be displayed on the printer 30 by, for example, implementing a web server function in the image server 10 and a web browser function in the printer 30. This technique allows the printer 30 to display HTML data according to the HTTP protocol, which is a versatile protocol.

(6) Whereas the case where the image search process is also executed using a string containing a plurality of sensitivity words has been taken as an example in the above embodiments, the image server 10 may be configured to accept only a string containing only one sensitivity word and one noun or to accept only a string containing only one sensitivity word (the number of nouns is not specified). If the image server 10 receives a string that does not apply to the above type of string, the image server 10 may request the client computer, such as the printer 30, for re-entry of a string or notify the client computer that search is not executed.

The invention has been described above using embodiments and variations, although they are intended for a better understanding of the invention and do not limit the invention. The invention can be changed or modified without departing from the spirit and scope of the invention and includes equivalents thereof.

What is claimed is:

1. An apparatus comprising:
a string-accepting section that accepts a string;
a first retrieval section that retrieves a first characteristic to be used for image search from a database storing sensitivity words and nouns in association with characteristics using a combination of a sensitivity word and a noun extracted from the string; and
a search section that searches for an image using the first characteristic.

2. The apparatus according to claim 1, further comprising:
an image-accepting section that accepts an image; and
a second retrieval section that retrieves a second characteristic from the image accepted by the image-accepting section;
wherein the search section searches for an image using the first and second characteristics.

3. The apparatus according to claim 2, wherein the string-accepting section accepts a string associated with the image accepted by the image-accepting section.

4. The apparatus according to claim 3, wherein, if a plurality of sensitivity words are extracted from the string, the first retrieval section retrieves first characteristics corresponding to the individual sensitivity words.

5. A method executed by a computer, comprising:
accepting a string;
retrieving a first characteristic to be used for image search from a database storing sensitivity words and nouns in association with characteristics using a combination of a sensitivity word and a noun extracted from the string; and
searching for an image using the first characteristic.
